(19) United States
(12) Patent Application Publication
(10) Pub. No.: US 2010/0225462 A1
(43) Pub. Date: Sep. 9, 2010

(54) In-Vehicle emergency report apparatus

(75) Inventors: Hiroaki Ito, Nisshin-city (JP); Yoshio Koie, Handa-city (JP); Shinji Kamiya, Kariya-city (JP); Shinichi Suzuki, Okazaki-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/660,639

(22) Filed: Mar. 2, 2010

(30) Foreign Application Priority Data
Mar. 4, 2009 (JP) 2009-51270

(51) Int. Cl. B60Q 1/00; G08B 21/00; G08B 23/00

(52) U.S. Cl. 340/438; 340/540; 340/693.1

(57) ABSTRACT

In an emergency report apparatus in a vehicle, even though a power switch is turned into an OFF state, an execution enabled state of an emergency report process is maintained when an occupant is determined to be in the vehicle. Therefore, even when a necessity of executing an emergency report process arises after the power switch is turned into the OFF state, it is unnecessary to turn the power switch into the ON state, thereby improving the usability. In addition, after the power switch is turned into the OFF state, an execution disabled state is designated when the occupant is determined to be not in the vehicle. Such an execution disabled state restricts the electric power supply from an in-vehicle battery, thereby reducing the power consumption and helping prevent the battery from running out.

### CROSS REFERENCE TO RELATED APPLICATION

The present application is based on and incorporates herein by reference Japanese Patent Application No. 2009-51270 filed on Mar. 4, 2009.

### FIELD OF THE INVENTION

The present invention relates to a an in-vehicle emergency report apparatus, which can help prevent a battery from running out while improving usability.

### BACKGROUND OF THE INVENTION

[Patent document 1] JP-H11-250379A

There is known an emergency report apparatus mounted in a vehicle for executing a report process to report that an occupant is in an emergency state to an outside of the vehicle (for example, see Patent document 1). The apparatus in Patent document 1 continues supplying electric power during a predetermined time even after a key switch is turned into an OFF state. Such a configuration can improve the usability in cases that a necessity of reporting an emergency arises after the key switch is turned into the OFF state.

As explained above, the apparatus in Patent document 1 certainly continues supplying of the electric power during a predetermined time when the key switch is turned into the OFF state; thus, supplying of the electric power is continued even in the case that any emergency report is unnecessary because the key switch is turned into the OFF state and the occupant gets off the vehicle. Therefore, the electric power may be consumed uselessly. This may result in a risk that the battery runs out.

In contrast, a necessity of the emergency report may arise after the above predetermined time elapses since the key switch is turned into the OFF state. In such a case, it is necessary for an occupant to dare to turn the key switch into the ON state in spite of the emergency state, therefore worsening the usability.

In addition, there is another emergency report apparatus provided with an indicator, which is turned on when an emergency report is presently possible or available. If the indicator is uselessly turned on without any occupant inside of the vehicle, the lighting indicator per se appears undesirable.

### SUMMARY OF THE INVENTION

The present invention is made in view of the above situation. It is an object of the present invention to provide an in-vehicle emergency report apparatus which can help prevent a battery from running out while improving usability.

To achieve the above object, according to an example of the present invention, an in-vehicle emergency report apparatus is provided in a vehicle for executing an emergency report process to report to an outside of the vehicle that an occupant is in an emergency state. In the apparatus, an operation state switching section is configured to switch, with respect to an emergency report process, (i) an execution enabled state in which an electric power is supplied from an in-vehicle battery to thereby enable an emergency report process and (ii) an execution disabled state in which an electric power supply from the in-vehicle battery is limited to thereby disable an emergency report process, by designating the execution enabled state or the execution disabled state. An occupant determination section is configured to determine whether an occupant is in the vehicle. Herein, in case that a power switch of the vehicle is turned into an OFF state, the operation state switching section is further configured to designate (i) the execution enabled state of the emergency report process, when the occupant determination section determines that the occupant is in the vehicle, and (ii) the execution disabled state of the emergency report process, when the occupant determination section determines that the occupant is not in the vehicle.

Under such a configuration, in cases that it is determined that an occupant is in the vehicle even if the power switch is turned off, an execution of an emergency report process is in an enabled state. Therefore, when the necessity of reporting an emergency arises after the power switch is turned into the OFF state, it is unnecessary for the occupant to turn the power switch into the ON state, thereby improving the usability. In contrast, in cases that it is determined that an occupant is not in the vehicle after the power switch is turned off, an execution of an emergency report is in a disabled state. Such a disabled state of the execution of an emergency report process restricts the electric power supply from the in-vehicle battery, thereby reducing the power consumption and helping prevent the battery from running out.

As another example of the present invention, a method for executing an emergency report process in an in-vehicle emergency report apparatus in a vehicle is provided to report to an outside of the vehicle that an occupant is in an emergency state. The method comprises: determining whether a power switch of the vehicle is turned into an OFF state; determining whether an occupant is in the vehicle when determining that the power switch is turned into the OFF state; and designating (i) an execution enabled state of the emergency report process, when it is determined that the occupant is in the vehicle, the execution enabled state being a state in which an electric power is supplied from an in-vehicle battery to thereby enable an emergency report process, and (ii) an execution disabled state of the emergency report process, when it is determined that the occupant is not in the vehicle, the execution disabled state being a state in which an electric power supply from the in-vehicle battery is limited to thereby disable an emergency report process.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram of an overall configuration of an in-vehicle emergency report apparatus and relevant other in-vehicle apparatuses according to an embodiment of the present invention; and

FIG. 2 is a flowchart diagram which illustrates a process relative to a power control of the in-vehicle emergency report apparatus.

### DETAILED DESCRIPTION OF THE PREFERRED EMBODIMENTS

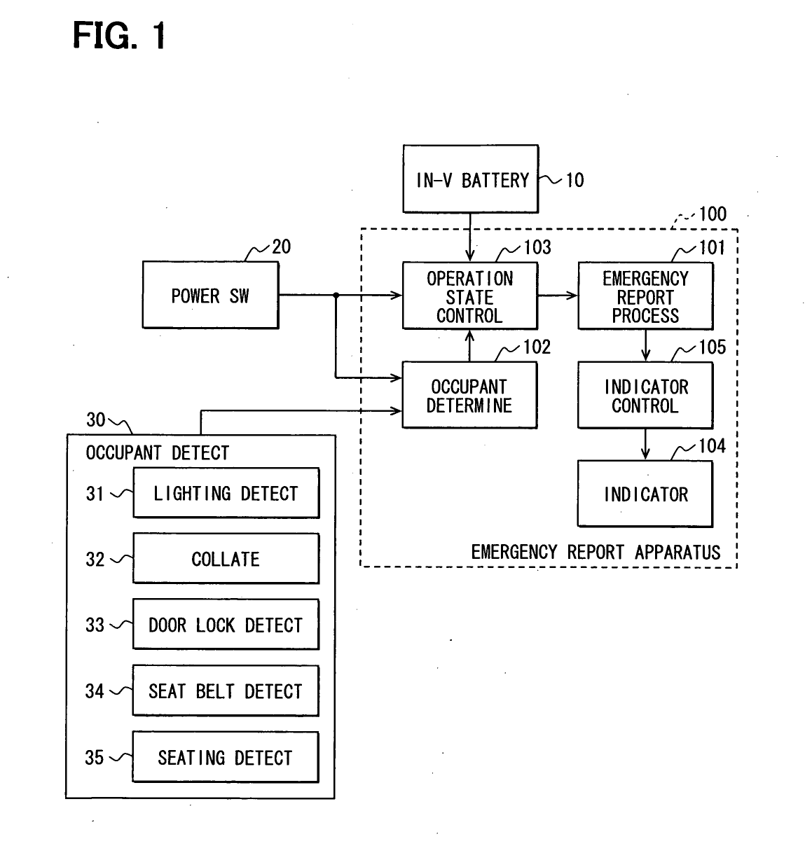

The following describes an embodiment of the present invention with reference to drawings. FIG. 1 is a block diagram of an overall configuration of an in-vehicle emergency report apparatus 100 and relevant other in-vehicle apparatuses mounted in a subject vehicle according to the embodiment of the present invention.

An in-vehicle battery 10 is supply electric power to various in-vehicle apparatuses including the in-vehicle emergency report apparatus 100. A power switch 20 is arranged in a position allowing an occupant who is seated in a driver's seat in the vehicle compartment to operate. When the occupant operates the power switch 20, a power source position or state is switched or designated among an OFF position or state, an accessory-ON position or state, and an ignition-ON position or state. The power switch 20 may be a rotating type switch equipped with a key insertion portion where a vehicle key is inserted, or a push type switch which does not have any key insertion portion at all.

An occupant detection device 30 is to output an occupant detection signal used in order that an occupant determination device 102 of the in-vehicle emergency report apparatus 100 determines the presence or absence of an occupant in the vehicle, i.e., in a compartment of the vehicle. As illustrated in FIG. 1, a room lamp lighting detection device 31, an in-vehicle collator 32, a door lock detection device 33, a seat belt fastening detection device 34, or a seating sensor 35 functions as an occupant detection device 30. It is noted that all the above devices or the like 31 to 35 are unnecessary, but at least one of them is necessary. In addition, another device or the like other than the above devices or the like 31 to 35 may be provided to be an occupant detection device 30.

The room lamp lighting detection device 31 is to detect a lighting state (either an ON state indicating the room lamp being turned on or an OFF state indicating the room lamp being turned off) of a room lamp (for example, a lamp on a vehicle room ceiling, a courtesy lamp) of the vehicle compartment, thereby outputting a signal for indicating a detection result as an occupant detection signal.

The in-vehicle collator 32 is to execute wireless communications with a portable apparatus carried or held by a user of the vehicle, and to execute a code collation between a code in the portable apparatus and a code in the collator 32 per se. When the code collation is affirmatively completed, i.e., when both the codes accord with each other, a predetermined function such as an engine start permission is thereby executed. In addition, the in-vehicle collator 32 is provided with a vehicle-inside antenna for forming a detection area inside the vehicle (i.e., inside of the vehicle compartment) and a vehicle-outside antenna for forming a detection area outside of the vehicle or surrounding the vehicle. Such a vehicle-inside antenna can limit a wireless communications area inside of the vehicle compartment, thereby detecting whether a portable apparatus is present in the vehicle compartment. A signal which indicates whether a portable apparatus is present inside of the vehicle compartment is thus outputted as an occupant detection signal.

The door lock detection device 33 and the seat belt fastening detection device 34 are to respectively detect a locked state of a vehicle door, and a fastened state of a seat belt, each outputting a signal for indicating a detection result as an occupant detection signal. The seating sensor 35 is to detect whether an occupant is seated on a seat of the vehicle compartment, thereby outputting a signal for indicating a detection result as an occupant detection signal. Furthermore, the seat belt fastening detection device 34 or the seating sensor 35 can be designed to output a detection result for every seat belt or every seat as an occupant detection signal, or output only a detection result relative to the driver's seat as an occupant detection signal.

The in-vehicle emergency report apparatus 100 includes an emergency report processor 101, an occupant determination device 102, an operation state control device 103, an indicator 104, and an indicator lighting control device 105.

It is noted that, of the in-vehicle emergency report apparatus 100, the respective functions of the emergency report processor 101, the occupant determination device 102, the operation state control device 103, and the indicator lighting control device 105 may be integrated collectively into a control circuit mainly including a microprocessor as respective sections.

The emergency report processor 101 executes an emergency report process, when a report switch (unshown) is pushed by an occupant in the vehicle. Such an emergency report process is to wirelessly report or notify to an outside of the vehicle that an occupant of the subject vehicle is in an emergency state.

The occupant determination device 102 is designed to receive a signal, which indicates a power source position or state, from the power switch 20, and an occupant detection signal from the occupant detection device 30, thereby determining whether an occupant is present in the vehicle compartment using the received signals.

For example, a signal, which indicates the lighting state of the room lamp, is received from the room lamp lighting detection device 31 as an occupant detection signal. In such cases, the occupant determination device 102 determines the opened state or closed state of a vehicle door based on the received occupant detection signal. That is, the following is based on the condition that the room lamp is turned into an ON state or an OFF state in conjunction with the opened state or the closed state of the vehicle door. If the room lamp is turned into the ON state, it is determined that the vehicle door is open. If the room lamp is turned into the OFF state, it is determined that the vehicle door is close. After the power position is turned into the OFF position, it is determined that the door of the vehicle opens and then closes based on the ON state and OFF state of the room lamp. The sequence that the power position turns into the OFF position, and the door of the vehicle opens and then closes again can provide an inference that the occupant opened the door and thereby got off the vehicle. Therefore, even if it is determined that the power position turns into the OFF position while the door of the vehicle opens, it is determined that the occupant is present inside of the vehicle compartment until it is determined that the door is then closed. When it is determined that the vehicle door is closed, it is determined that the occupant is not present in the vehicle compartment.

In addition, when the signal, which indicates whether a portable apparatus exists in the vehicle compartment, is supplied from the in-vehicle collator 32 as an occupant detection signal, the occupant determination device 102 determines that the occupant is present inside of the vehicle compartment when determining that the portable apparatus is inside of the vehicle compartment based on the supplied occupant detection signal, while determining that the occupant is not present inside of the vehicle compartment when determining that the portable apparatus is not inside of the vehicle compartment based on the supplied occupant detection signal.

In addition, when the signal, which indicates the door lock state, is received from the door lock detection device 33 as an occupant detection signal, the occupant determination device 102 determines that the occupant is present inside of the vehicle compartment during a period for which the door of the vehicle is in the unlocked state after the power position turns into the OFF position. Then, when the door of the vehicle thereafter comes to be in the locked position, it is determined that the occupant is not present inside of the vehicle compartment.

In addition, when the signal which indicates the seat belt fastening state is received from the seat belt fastening detection device 34 as an occupant detection signal, the occupant determination device 102 determines that the occupant is present inside of the vehicle compartment in cases that the seat belt is in the fastened state even after the power position turns into the OFF position. Then, when the seat belt comes to be in the not-fastened state, it is determined that the occupant is not present inside of the vehicle compartment.

In addition, when the signal which indicates a detection result of the seating sensor 35 is received as an occupant detection signal, the occupant determination device 102 determines that the occupant is present inside of the vehicle compartment in cases that it is determined that the occupant is seated in the seat even after the power position turns into the OFF position. It is determined that the occupant is not present inside of the vehicle compartment when it is determined that the occupant is not seated in the seat.

It is noted that the determination as to the occupant's presence or absence is executed at least, at the time when the power position is changed into the OFF position from the accessory-ON position (namely, immediately after coming to be in the OFF position). In addition, thereafter, such a determination may be periodically executed during a predetermined period. In addition, the determination may be continued until it is determined that the occupant is not present in the vehicle compartment.

The operation state control device 103 functions as an operation state switching section or means to switch an execution enabled state and an execution disabled state (i.e., to designate one of the execution enabled state and the execution disabled state) with respect to an emergency report process. In the execution enabled state, an electric power is supplied from the in-vehicle battery 10 to the emergency report processor 101, thereby making it possible to execute an emergency report process. In contrast, in the execution disabled state, the supply of an electric power is restricted from the in-vehicle battery 10 to the emergency report processor 101, thereby making it impossible to execute an emergency report process. It is further noted that the execution disabled state of an emergency report process signifies either a power OFF state or a sleep state. In the power OFF state, the electric power supply is shut down to the emergency report processor 101. In the sleep state, the electric power supplied to the emergency report processor 101 is kept in a state significantly less than that in the execution enabled state. Whether to adopt the power OFF state or the sleep state may be determined or designed as needed based on the required specification of the apparatus. Furthermore, the operation state control device 103 includes a changeover switch and a switch control section.

The above operation state control device 103 executes the change or designation of the execution enabled state and the execution disabled state of the emergency report process based on the power position and the occupant present or not present in the vehicle compartment. For instance, when the power position is in the accessory-ON position or the ignition-ON position, the execution enabled state of an emergency report process is designated regardless of whether or not an occupant is present in the vehicle compartment.

In contrast, after the power position is changed from the accessory-ON state to the OFF position, the execution enabled state of an emergency report process is designated when the occupant determination device 102 determines that the occupant is present in the vehicle compartment; the execution disabled state of an emergency report process is designated when the occupant determination device 102 determines that the occupant is not present in the vehicle compartment.

Furthermore, it is noted that the execution disabled state of an emergency report process may be designated after a predetermined time period elapses in the following case. That is, when a determination as to the occupant's presence or absence is made only once immediately after the power position is changed into the OFF position from the accessory-ON position, the occupant determination device 102 determines that an occupant is present inside of the vehicle compartment at such a one-time determination.

The indicator 104 is to notify an occupant present inside of the vehicle compartment of the execution enabled state of an emergency report process being presently designated. The indicator 104 is, for instance, an LED, which is arranged at a position where the occupant of the vehicle compartment can easily see it. The indicator 104 is controlled by the indicator lighting control device 105 in respect of changing the OFF state and the ON state.

The indicator lighting control device 105 detects whether the emergency report processor 101 is in the execution enabled state or the execution disabled state of an emergency report process. When in the execution enabled state, the indicator 104 is caused to turn into the ON state so as to notify the occupant of the execution enabled state being presently designated. When in the execution disabled state, the indicator 104 is caused to turn into the OFF state.

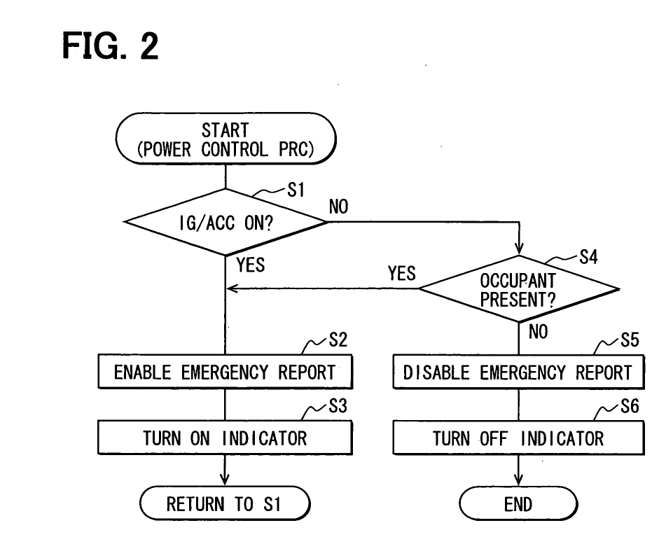

FIG. 2 is a flowchart diagram which illustrates a power control process of the in-vehicle emergency report apparatus 100. The present process is an example in which the execution enabled state is maintained until it is determined that the occupant is not present inside of the vehicle compartment.

It is further noted that a flowchart or the processing of the flowchart in the present application includes sections (also referred to as steps), which are represented, for instance, as S1. Further, each section can be divided into several sub-sections while several sections can be combined into a single section. Furthermore, each of thus configured sections can be referred to as a means or unit and achieved not only as a software device but also as a hardware device.

At S1, it is determined whether the power switch 20 is at the ignition-ON position or state or the accessory (ACC)-ON position or state. When the power switch 20 is either in the ignition-ON position or the accessory-ON position, the affirmative determination is made at S1. The processing thereby proceeds to S2.

At S2, the emergency report processor 101 is changed into the execution enabled state of an emergency report process. At S3, the indicator 104 is changed into the ON state. Then, the processing returns to S1.

When the power switch 20 is in the OFF state at S1, the processing proceeds to S4. At S4, it is determined whether an occupant is present inside of the vehicle compartment. When the determination at S4 is affirmed, the above-mentioned processing at S2 and S3 is executed. Then the processing returns to S1. When the determination at S4 is negated, the processing proceeds to S5. The emergency report processor 101 is immediately changed into the execution disabled state of an emergency report process. At S6, the indicator 104 is changed into the tuning OFF state. The processing is then ended.

As the explained above, according to the present embodiment, in cases that it is determined that an occupant is present in the vehicle compartment even though the power switch 20 is turned into the OFF state, the execution enabled state of an emergency report process is maintained. Therefore, when the necessity of reporting an emergency arises after the power switch 20 is turned into the OFF state, it is unnecessary for the occupant to turn the power switch 20 into the ON state, thereby improving the usability. In contrast, in cases that it is determined that an occupant is not in the vehicle compartment after the power switch 20 is turned into the OFF state, an execution disabled state of an emergency report process is newly designated. Such a disabled state of the execution of an emergency report process restricts the electric power supply from the in-vehicle battery 10, thereby reducing the power consumption and helping prevent the battery 10 from running out.

Each or any combination of processes, functions, sections, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a computer-readable storage media or can be downloaded and installed in a computer via a communications network.

Aspects of the disclosure described herein are set out in the following clauses.

As an aspect of the disclosure, an in-vehicle emergency report apparatus is provided in a vehicle for executing an emergency report process to report to an outside of the vehicle that an occupant is in an emergency state. In the apparatus, an operation state switching section is configured to switch, with respect to an emergency report process, (i) an execution enabled state in which an electric power is supplied from an in-vehicle battery to thereby enable an emergency report process and (ii) an execution disabled state in which an electric power supply from the in-vehicle battery is limited to thereby disable an emergency report process, by designating the execution enabled state or the execution disabled state. An occupant determination section is configured to determine whether an occupant is in the vehicle. Herein, in case that a power switch of the vehicle is turned into an OFF state, the operation state switching section is further configured to designate (i) the execution enabled state of the emergency report process, when the occupant determination section determines that the occupant is in the vehicle, and (ii) the execution disabled state of the emergency report process, when the occupant determination section determines that the occupant is not in the vehicle.

As an optional aspect of the in-vehicle emergency report apparatus, an indicator may be configured to turn on for notifying an occupant of the execution enabled state of the emergency report process when the execution enabled state is designated, and turn off when the execution disabled state is designated.

Conventionally, when an execution of an emergency report process is in an enabled state even without an occupant inside of the vehicle, i.e., inside of a compartment of the vehicle, the indicator in the vehicle is turned on even in a useless state where no occupant is in the vehicle. In contrast, under the configuration of the present optional aspect, when it is determined that no occupant is in the vehicle, the execution of an emergency report process is switched into a disabled state. The indicator can be thus prevented from lighting up or turning on in the unnecessary state where the occupant is not in the vehicle.

The occupant determination section can be achieved by the optional aspects as follows, for instance.

The occupant determination section may be further configured to determine that the occupant is in the vehicle from a time when the power switch is turned into an OFF state to a time when a door of the vehicle is turned from an opened state to a closed state, and determine that the occupant is not in the vehicle after the time when the door of the vehicle is turned from the opened state to the closed state.

The vehicle may be configured to execute a code collation with a portable apparatus using wireless communications. The vehicle may include an in-vehicle collator to limit an area of the wireless communications inside of the vehicle. The occupant determination section may be further configured to determine that the occupant is in the vehicle based on a result that the in-vehicle collator detects that the portable apparatus is in the vehicle and determine that the occupant is not in the vehicle based on a result that the in-vehicle collator does not detect that the portable apparatus is in the vehicle.

The occupant determination section may be further configured to determine, after the power switch is turned into an OFF state, (i) that the occupant is in the vehicle during a period for which a door of the vehicle is in an unlocked state, and (ii) that the occupant is not in the vehicle based on a result that the door of the vehicle is turned from the unlocked state into a locked state.

The occupant determination section may be further configured to determine that the occupant is in the vehicle based on a detection that the seat belt of the vehicle is in a fastened state, and determine that the occupant is not in the vehicle based on a detection that the seat belt of the vehicle is in a not-fastened state.

The occupant determination section may be further configured to determine that the occupant is in the vehicle based on a detection that the occupant is detected by the seating sensor, and determine that the occupant is not in the vehicle based on a detection that the occupant is not detected by the seating sensor.

It will be obvious to those skilled in the art that various changes may be made in the above-described embodiments of the present invention. However, the scope of the present invention should be determined by the following claims.

What is claimed:

1. An in-vehicle emergency report apparatus in a vehicle for executing an emergency report process to report to an outside of the vehicle that an occupant is in an emergency state, the apparatus comprising:
an operation state switching section configured to switch, with respect to an emergency report process,
(i) an execution enabled state in which an electric power is supplied from an in-vehicle battery to thereby enable an emergency report process and
(ii) an execution disabled state in which an electric power supply from the in-vehicle battery is limited to thereby disable an emergency report process,
by designating the execution enabled state or the execution disabled state; and
an occupant determination section configured to determine whether an occupant is in the vehicle,
wherein in case that a power switch of the vehicle is turned into an OFF state,
the operation state switching section is further configured to designate
(i) the execution enabled state of the emergency report process, when the occupant determination section determines that the occupant is in the vehicle, and
(ii) the execution disabled state of the emergency report process, when the occupant determination section determines that the occupant is not in the vehicle.

2. The in-vehicle emergency report apparatus according to claim 1, further comprising:
an indicator configured to
turn on for notifying an occupant of the execution enabled state of the emergency report process when the execution enabled state is designated, and
turn off when the execution disabled state is designated.

3. The in-vehicle emergency report apparatus according to claim 1,
the occupant determination section being further configured to
determine that the occupant is in the vehicle from a time when the power switch is turned into an OFF state to a time when a door of the vehicle is turned from an opened state to a closed state, and
determine that the occupant is not in the vehicle after the time when the door of the vehicle is turned from the opened state to the closed state.

4. The in-vehicle emergency report apparatus according to claim 1, wherein:
the vehicle is configured to execute a code collation with a portable apparatus using wireless communications; and
the vehicle includes an in-vehicle collator to limit an area of the wireless communications inside of the vehicle,
the occupant determination section being further configured to
determine that the occupant is in the vehicle based on a result that the in-vehicle collator detects that the portable apparatus is in the vehicle and
determine that the occupant is not in the vehicle based on a result that the in-vehicle collator does not detect that the portable apparatus is in the vehicle.

5. The in-vehicle emergency report apparatus according to claim 1,
the occupant determination section being further configured to determine, after the power switch is turned into an OFF state,
(i) that the occupant is in the vehicle during a period for which a door of the vehicle is in an unlocked state, and
(ii) that the occupant is not in the vehicle based on a result that the door of the vehicle is turned from the unlocked state into a locked state.

6. The in-vehicle emergency report apparatus according to claim 1,
the occupant determination section being further configured to
determine that the occupant is in the vehicle based on a detection that the seat belt of the vehicle is in a fastened state, and
determine that the occupant is not in the vehicle based on a detection that the seat belt of the vehicle is in a not-fastened state.

7. The in-vehicle emergency report apparatus according to claim 1, the occupant determination section being further configured to
determine that the occupant is in the vehicle based on a detection that the occupant is detected by the seating sensor, and
determine that the occupant is not in the vehicle based on a detection that the occupant is not detected by the seating sensor.

8. A method for executing an emergency report process in an in-vehicle emergency report apparatus in a vehicle so as to report to an outside of the vehicle that an occupant is in an emergency state, the method comprising:
determining whether a power switch of the vehicle is turned into an OFF state;
determining whether an occupant is in the vehicle when determining that the power switch is turned into the OFF state; and
designating
(i) an execution enabled state of the emergency report process, when it is determined that the occupant is in the vehicle, the execution enabled state being a state in which an electric power is supplied from an in-vehicle battery to thereby enable an emergency report process, and
(ii) an execution disabled state of the emergency report process, when it is determined that the occupant is not in the vehicle, the execution disabled state being a state in which an electric power supply from the in-vehicle battery is limited to thereby disable an emergency report process.
